(19) United States
(12) Patent Application Publication
(10) Pub. No.: US 2023/0067038 A1
(43) Pub. Date: Mar. 2, 2023

(54) TILE INSTALLATION SYSTEM WITH FORCE SENSOR AND RELATED DEVICES AND METHODS

(71) Applicant: Ag Leader Technology, Ames, IA (US)

(72) Inventors: Craig Riemersma, Bondurant, IA (US); Joseph Irwin, JR., West Terre Haute, IN (US); Bryan Horsman, Terre Haute, IN (US)

(21) Appl. No.: 17/902,366

(22) Filed: Sep. 2, 2022

Related U.S. Application Data
(60) Provisional application No. 63/240,129, filed on Sep. 2, 2021.

(51) Int. Cl. E02F 5/10; G01L 5/00; E02F 9/26; E02F 9/24

(52) U.S. Cl. CPC E02F 5/102; G01L 5/0038; G01L 5/0061; E02F 9/26; E02F 9/24

(57) ABSTRACT

A tile plow system, comprising a force sensor configured to detect an amount of tension on a conduit being fed through a tile plow, a system module in communication with the force sensor, and a display in communication with the system module. The system module comprises a processor and a memory. The tile plow system wherein the amount of tension on the conduit is compared to a threshold tension range, and wherein when the amount of tension of the conduit is outside of the threshold tension range corrective action is taken by the system.

### CROSS-REFERENCE TO RELATED APPLICATION(S)

This application claims the benefit under 35 U.S.C. § 119(e) to U.S. Provisional Application 63/240,129, filed Sep. 2, 2021, and entitled “Tile Installation System with Force Sensor,” which is hereby incorporated herein by reference in its entirety for all purposes.

### TECHNICAL FIELD

The various embodiments herein relate to devices for underground installation of elongate flexible pipes and tubes, including, for example, underground cables (electrical or fiber optic) and drainage tiles. Certain implementations relate to pitch plows and methods of laying a flexible pipe or tube underground. More specific embodiments include agricultural drainage tile plows.

### BACKGROUND

Drainage tile plows are configured to install underground flexible pipe under tillable soil to enhance drainage of water from a tillable field. As the tile plow is pulled through the ground, the plow temporarily creates a trench and concurrently installs the flexible pipe.

As depicted in FIG. 1, a known, conventional pitch plow 10, such as a drainage plow 10, includes a frame 12 and a shank 14 that is pivotally mounted to the frame 12. The shank 14 defines a forward cutting edge 16, or shear 16. A hydraulic control 18, such as an actuator 18, is disposed between the shank 14 and the frame 12 and adapted to pivotally adjust the shank 14 with respect to the frame 12. The hydraulic actuator 18 may be operated manually by an operator via a control lever (not shown) or automatically via an electronic control (not shown), as would be appreciated.

A prime mover 20, such as a tractor 20, propels the plow 10. Control of the propulsion and steering of the tractor 20 and its 3-point hitch (not shown) is through a main user interface of the tractor 20, as is conventional. The frame 12 of plow 10 may be coupled to tractor 20 by one or more pins 22 inserted through holes in the outer arms (not shown) and a pin 24 through the hole in an upper arm 26 of a conventional 3-point hitch of tractor 20, as is the practice. Alternatively, the frame 12 may be coupled to the tractor 20 by a drawbar hitch or other known connection techniques.

In these known implementations, the shank 14 is pivotally attached to the frame 12 by a pin 28. As would be understood, the hydraulic actuator 18 extends and retracts, transmitting force through a pin 30 causing the shank 14 to pivot about the pin 28. A skid plate 32 is welded to the bottom of the shank 14. The shear 16 is mounted to the shank 14 and its tip functions as the cutting edge of the plow 10. A boot 34 of the shank 14 provides a channel (not shown) through which flexible pipe 36 passes as it is installed by the plow 10. The intake 38 of the boot 34 receives the flexible pipe 36, and a discharge 40 lays the flexible pipe 36 in the trench 42.

To install the flexible pipe 36, the tractor 20 is maneuvered such that it points in the direction in which pipe 36 is to be installed, and the plow 10 is positioned over a trench 42 or ditch 42, as is depicted in FIG. 1. The plow 10 is lowered into the trench 42 using the hydraulically actuated 3-point hitch. An operator feeds flexible pipe 36 or conduit 36 by hand into the intake 38 of boot 34 until the flexible pipe 36 comes out of the discharge 40 at the bottom of the boot 34 and lies upon the bottom of trench 42. The pipe 36 is anchored in place along the bottom of the trench 42, such as by placing weighty soil upon it or by standing on it. The tractor 20 drives forward, exerting force on the plow 10 via the pins 22 and 24, thus drawing the plow 10 forward. As the plow 10 is drawn forward, the shear 16 displaces soil and thereby cuts a subsurface upon which the flexible pipe 36 is laid. The shank 14 displaces soil, temporarily opening a trench 42 through which said shank 14 passes. The weight of soil upon and around the installed flexible pipe 36 holds the pipe 36 in place, causing flexible pipe 36 to continuously be drawn through the boot 34 as the plow 10 progresses forward.

One disadvantage of known tile plows, such as plow 10, is that the tile plow operator may not be aware of issues relating to the flexible pipe (such as pipe 36) feeding into the plow 10 and boot 34 and thereby being installed incorrectly, including excessive tension being applied to the flexible pipe during installation. For example, the flexible pipe (such as pipe 36) can be stretched and may break underground during installation. Stretching flexible pipe can weaken the pipe and ultimately lead to collapse. A broken pipe can completely disrupt water flow and thus require immediate repair and/or re-attachment to the connected pipe.

Known systems and devices require either visual monitoring by the operator (with the operator constantly visually monitoring the flexible pipe going into the plow) or a system that measures the length of flexible pipe going into the hopper and compare it with the installation speed of the plow.

There is a need in the art for an improved plow or plow component that allows for monitoring the tension applied to the flexible pipe during installation.

### BRIEF SUMMARY

In Example 1, a tile plow system, comprising a force sensor assembly configured to detect an amount of tension on a conduit being fed through a tile plow, a system module in communication with the force sensor assembly, the system module comprising a processor and a memory, and a display in communication with the system module, wherein the amount of tension on the conduit is compared to a threshold tension range, and wherein when the amount of tension on the conduit is outside of the threshold tension range a corrective action is taken by the tile plow system.

Example 2 relates to the tile plow system of Example 1, wherein the corrective action includes one or more of change in tractor speed, change in feeder speed, and cessation of tilling.

Example 3 relates to the tile plow system of Example 1, wherein the force sensor assembly comprises a contact plate disposed within a lumen of a shank of the tile plow operatively coupled to a force sensor.

Example 4 relates to the tile plow system of Example 3, wherein force applied to the contact plate is transferred to the force sensor.

Example 5 relates to the tile plow system of Example 3. further comprising a sensor casing configured to be a protective cover over the force sensor assembly.

Example 6 relates to the tile plow system of Example 1, further comprising a GNSS receiver in communication with the system module.

Example 7 relates to the tile plow system of Example 1, wherein the system module emits a warning when the amount of tension on the conduit is within a cautionary range.

In Example 8, a tile installation device, comprising a sensor assembly, comprising a contact plate disposed within a lumen of a shank, and a force sensor coupled to the contact plate via a coupling body; and a processor configured to process force data from the force sensor, wherein force applied to a flexible pipe exiting the shank is applied to the contact plate and actual force is detected by the force sensor, the actual force is compared to a threshold force range, and when the actual force is outside of the threshold force range the tile installation device applies a corrective action.

Example 9 relates to the tile installation device of Example 8, wherein the force sensor is a load cell.

Example 10 relates to the tile installation device of Example 8, further comprising a sensor casing disposed over the force sensor.

Example 11 relates to the tile installation device of Example 8, wherein the contact plate is disposed within the lumen of the shank proximal to a discharge opening of the shank.

Example 12 relates to the tile installation device of Example 8, wherein the corrective action is one or more of change in tractor speed, change in feeder speed, cessation of tilling, and emitting an alarm.

Example 13 relates to the tile installation device of Example 8, further comprising a display in communication with the processor, the display configured to display one or more of actual force and threshold force range.

Example 14 relates to the tile installation device of Example 13, wherein the display emits a visual or auditory warning when the threshold force range is exceeded.

In Example 15 a tile plow, comprising a shank pivotally attached to a frame, a channel defined through the shank, a force sensor apparatus, comprising a contact plate disposed within the channel, and a force sensor coupled to the contact plate, and a processor in communication with the force sensor, wherein actual force from the force sensor is transmitted to the processor, the actual force is compared to a threshold force range, and when the actual force is outside of the threshold force range the tile plow applies a corrective action.

Example 16 relates to the tile plow of Example 15, wherein the force sensor is a load cell.

Example 17 relates to the tile plow of Example 15, wherein the contact plate is disposed proximal to a discharge opening of the shank, wherein force applied to a pipe exiting the discharge opening is applied to the contact plate.

Example 18 relates to the tile plow of Example 15, wherein the corrective action is one or more of change in tractor speed, change in feeder speed, cessation of tilling, and emitting an alarm.

Example 19 relates to the tile plow of Example 15, wherein the threshold force range comprises three categories an acceptable range, a cautionary range, and a damaging range.

Example 20 relates to the tile plow of Example 15, wherein the corrective action to taken automatically by the tile plow.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a diagram of a prior known conventional pitch plow.

FIG. 2A shows a side view of a plow, according to one implementation.

FIG. 2B shows a side, magnified view of the sensor apparatus on a plow, according to one implementation.

FIG. 3 shows a schematic view of the sensor system, uninstalled, according to one implementation.

FIG. 4 is a flow diagram for operation of the system, according to one implementation.

FIG. 5 shows a wiring diagram for the system, according to one implementation.

FIG. 6A shows a perspective view of a load cell, according to one implementation.

FIG. 6B shows a front view of a load cell, according to one implementation.

FIG. 6C shows a side view of a load cell, according to one implementation.

FIG. 6D shows a rear view of a load cell, according to one implementation.

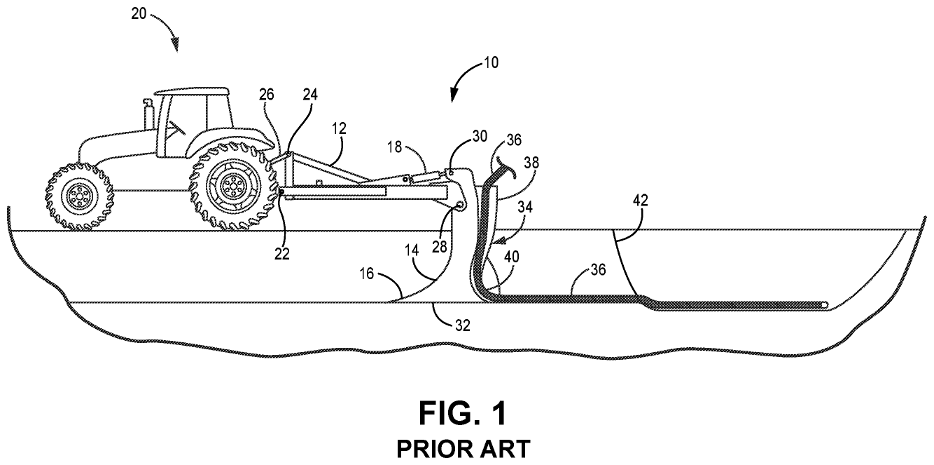

### DETAILED DESCRIPTION

The various embodiments disclosed or contemplated herein relate to devices for laying a flexible pipe or tube underground and related methods, including a sensor for monitoring the amount of force or tension being applied to the cable, pipe, tube, or tile. More specific embodiments include agricultural drainage tile plows or installation devices with such a sensor and/or sensing system. Alternatively, such devices can include those that install underground electrical cable, fiber optic cable, or other forms of flexible pipe underground. Regardless, the various embodiments herein are not reliant on knowing the speed of the installation device or the amount of flexible pipe being fed through the device, as is typically required in the known devices in the prior at.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. Pat. No. 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. patent application Ser. No. 16/752,989, filed Jan. 27, 2020, entitled “Dual Seed Meter and Related Systems and Methods,”U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. Patent Application 63/240,129, filed September 2, 2021, entitled “Tile Installation System with Force Sensor,” U.S. Patent Application 63/241,393, filed September 7, 2021, entitled “Row-by-Row Estimation System and Related Devices and Methods,” U.S. Patent Application 63/289,445, filed Dec. 14, 2021, entitled “Seed Tube Guard,” U.S. Patent Application 63/292,796, filed Dec. 22, 2021, entitled “Data Visualization and Analysis for Harvest Stand Counter,” U.S. Patent Application 63/299,724, filed Jan. 14, 2022, entitled “Agricultural Mapping,” U.S. Patent Application 63/302,824, filed Jan. 25, 2022, entitled “Seed Meter with Integral Mounting Method for Row Crop Planter,” U.S. Patent Application 63/303,144, filed Jan. 26, 2022, entitled “Load Cell Backing Plate,” U.S. Patent Application 63/315,850, filed Mar. 2, 2022, entitled “Cross Track Error Stalk Sensor,” U.S. Patent Application 63/346,665, filed May 27, 2022, entitled “Seed Delivery Tube Camera for Furrow Monitoring,” U.S. Patent Application 63/351,602, filed Jun. 13, 2022, entitled “Apparatus, Systems and Methods for Image Plant Counting,” U.S. Patent Application 63/357,082, filed Jun. 30, 2022, entitled “Seed Tube Guard,” U.S. Patent Application 63/357,284, filed Jun. 30, 2022, entitled “Grain Cart Bin Level Sharing,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” and U.S. Patent Application 63/400,943, filed Aug. 25, 2022, entitled “Combine Yield Monitor Automatic Calibration System Using Grain Cart with Weighing System, each of which is incorporated by reference herein.

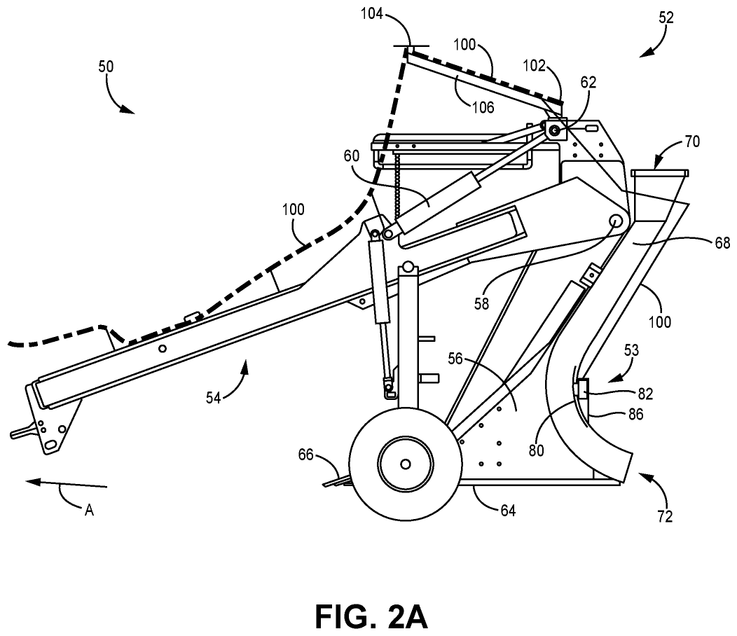

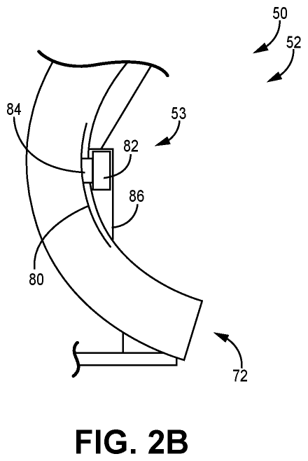

One exemplary implementation of an installation device (or “plow”) 50 with a pipe sensor system 52 having a pipe sensor apparatus 53 is shown in FIGS. 2A and 2B. The plow 50 has a frame 54 that may be coupled to a tractor or other prime mover (not shown) via any known mechanism or connection technique. The plow 50 also has a shank 56 that is pivotally attached to the frame 54 by a pin 58. Further, the plow 50 has a hydraulic actuator 60 that extends and retracts, transmitting force through a pin 62 causing the shank 56 to pivot about the pin 58. In certain embodiments, a skid plate 64 is attached to the bottom of the shank 56. In certain further embodiments, a shear 66 is mounted to the shank 56 such that its tip functions as the cutting edge of the shank 56. The shank 56 may also have a channel (or “lumen”) 68 defined therethrough that allows for passage of a flexible pipe (not shown) as the pipe is installed by the plow 50. An intake opening 70 defined at one end of the lumen 68 receives the flexible pipe (not shown). A discharge opening 72 defined at the other end allows for the flexible pipe (not shown) to extend out of the lumen 68 and to lay the flexible pipe (not shown) in the trench.

In various implementations, the system 50 has a sensor apparatus 53 having a contact plate 80 disposed within the lumen 68 of the shank 56. The contact plate 80 is coupled to a force sensor 82 with a coupling body 84 such that any force applied to the contact plate 80 is transferred to the force sensor 82 via the coupling body 84. In accordance with this specific embodiment, the sensor apparatus 53 also has a sensor casing 86 or cover 86 that serves as a protective cover 86 disposed over the sensor 82. In certain embodiments, the force sensor 82 is a load cell 82, as will be discussed in further detail below. Alternatively, the force sensor 82 can be any known sensor for measuring, recording, and/or transmitting the force applied to the contact plate 80.

In various implementations, the contact plate 80 is disposed within the lumen 68 at the curve or bend in the lumen 68 at or near the discharge opening 72. That is, the contact plate 80 is positioned to be in contact with the flexible pipe at the location where the pipe exits the shank 64, at or near the discharge opening 72, and is positioned in the target trench. As a result, the contact plate 80 is positioned such that any force applied to the pipe (not shown) as it exits the opening 72 and is placed in the target trench is applied to the contact plate 80. More specifically, as the plow 50 is pulled across the field in the forward direction (as indicated by arrow A) and the pipe (not shown) passes through the channel 68 and is positioned in the trench, any additional force or tension applied to the pipe as a result of a snag or other issue will result in the pipe applying additional force to the plate 80. The more tension placed on the pipe, the more the pipe will be urged against the contact plate 80. The additional force applied to the plate 80 will be transferred to the force sensor 82 via the coupling body 84 such that the force sensor 82 detects and measures that force.

Continuing with FIGS. 2A and 2B, according to one embodiment, the contact plate 80 is made of metal (including, for example, rolled metal), plastic, or any similar, substantially rigid material that allows for the flexible pipe passing through the channel 68 to slide along and in contact with the contact plate 80 with a minimal amount of friction.

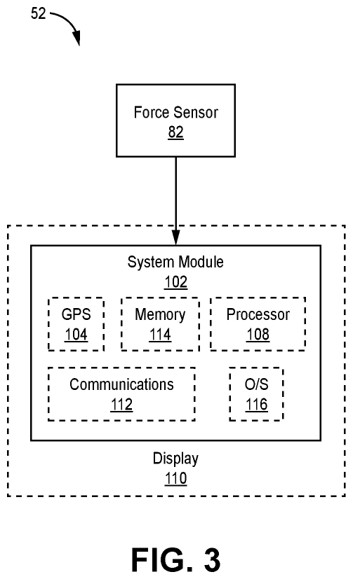

As best shown in FIG. 2A and FIG. 3, in accordance with certain implementations, in addition to the sensor apparatus 53, the system 50 has a connection cable 100 coupled to the force sensor 82 that extends from the sensor 82 to the system module 102 disposed on the plow 50. The module 102 contains a processor 108 that can be used to process the force information transmitted from the force sensor 82, as will be described in further detail below. Further, the cable 100 extends from the module 102 to the GNSS/GPS receiver/transmitter 104 disposed on the receiver arm 106. In addition, the cable 100 extends from the GPS receiver/transmitter 104 toward the front of the plow 50 along the frame 54 and from there extends to a display 110/interface 110 disposed within the tractor or other prime mover (not shown), as will be discussed in further detail below.

In use, the force sensor 82 transmits information collected about the amount of force applied to the contact plate 80 to the module 102 along the cable 100 or other communications component 112. According to one embodiment, the module 102 receives the force information and processes it to calculate the amount of pressure being applied to the plate 80 (and thus the amount of tension being applied to the flexible pipe passing through the channel 68). The module 102 then transmits this processed information to the display 110 in the prime mover (not shown) via the cable 100 or other communications component 112. As a result of this system 52, the operator disposed in the prime mover (not shown) can track the information on the interface 110/display 110 about how the flexible pipe is moving through the channel 68. Further, in certain embodiments, the interface 110 is configured to transmit a warning when the tension on the pipe exceeds of falls below threshold values. For example, the warning from the interface 11 can be a visual or auditory warning, or both. Alternatively, the warning can take any known form.

The system module 102 may include various additional processing and computing components necessary for the operation of the system 52, including receiving, recording, and processing the various signals, generating the requisite calculations and commanding the various hardware, software, and firmware components necessary to effectuate the various processes described herein. That is the system module 102 may additionally include a memory 114 and an operating system 116 or software and sufficient media to effectuate the described processes, as would be readily appreciated. The various system 52 components may be distributed about the plow 50, prime mover, or other components. In certain implementations, various components, for example a display 110 and/or memory 114 may be remote from the plow 50 and/or prime mover. In certain implementations, the processor 108, memory 114, operating system 116, or other components may be cloud based, as would be appreciated.

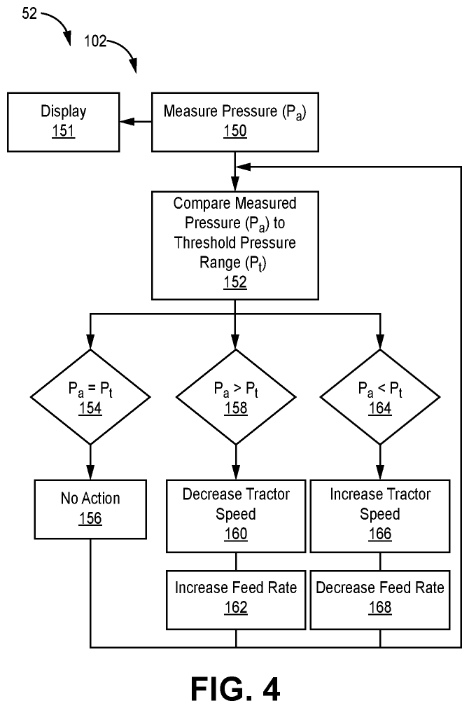

In one embodiment, the module 102 can contain software that can determine whether the force being applied to the flexible pipe is within an acceptable range or falls outside the acceptable range, such as is shown for example in FIG. 4. In various implementations, the system 52 is configured to measure pressure (Pₐ) (box 150) or tension and then compare the actual measured pressures (Pₐ) or tension to a threshold pressure/tension range (Pₜ). In various implementations, the threshold pressure/tension range (Pₜ) is a range of pressures/tensions that are acceptable. In alternative implementations, the system 52 may include more than one set of threshold pressure/tension ranges (Pₜ), for example, in one embodiment, the software or operator can place the amount of force (pressure and/or tension) being applied to the flexible pipe into one of three categories: (1) an acceptable (or “green”) range, (2) a cautionary (or “yellow”) range, and (3) a damaging (or “red”) range. As would be appreciated the amount of pressure or tension that the pipe/tile can handle without losing structural integrity may depend on the pipe/tile size, manufacturer, installation technique, level of caution of the operator, and other factors that would be recognized by those of skill in the art.

In certain embodiments, this information can be transmitted to the interface (shown at 110 in FIG. 3) to display/notify (box 151) the operator in real-time about the amount of tension being applied to the pipe such that the operator can act accordingly, such as by adjusting the tractor speed and/or the pipe feeder speed. In various alternative implementations, the action taken in response to the comparison of actual measured pressure and the threshold ranges may be automatic or semi-automatic.

For example, if the tension being applied is within the acceptable range (Pₐ=Pₜ) (box 154) as indicated by the interface 110 or automatically detected, then the operator or system 52 can continue to install the pipe into the target trench. That is, when Pₐ=Pₜ no action need be taken (box 156).

On the other hand, if the interface indicates that the tension being applied is within the cautionary range, the operator can either continue to install the pipe while closely monitoring the interface to ensure that the amount of tension soon lessens such that it again falls in the acceptable range or can stop to check for any snags or other issues with respect to the pipe. Alternatively, the system 52 may automatically emit a warning to the operator that the pressure is within a cautionary range.

In another example, if the interface 110 indicates that the tension is within the damaging range, that is where Pₐ>Pₜ (box 158), the operator may immediately stop the installation and attempt to identify and remove the issue causing the increased tension. Alternatively, the system 52 may emit a warning that the pressure is too high. In a still further implementations, the system 52 may either automatically or prompt an operator to decrease the tractor speed (box 160) and/or increase the feed rate of the feeder device (box 162).

In a further example, if the system 52 detects that the pressure is below the threshold range (Pₐ<Pₜ) (box 164), the system 52 may alert an operator of this condition. The system 52 may cause the tractor speed to increase (box 166) and/or the feeder to decrease the feed rate (box 168), either automatically or via prompting of an operator. Various alternative mechanisms for adjusting the tension of the pipe, as would be appreciated.

As noted, in various implementations, the module 102 can be coupled to a known automatic pipe feeder device (not shown) such that the speed of the pipe feeding device can be adjusted by the module 102 depending on the size of the pipe or other factors. Alternatively, the module 102 can transmit appropriate information to the interface 110 such that the operator can track the information about the pipe feeding device and adjust the speed thereof as necessary.

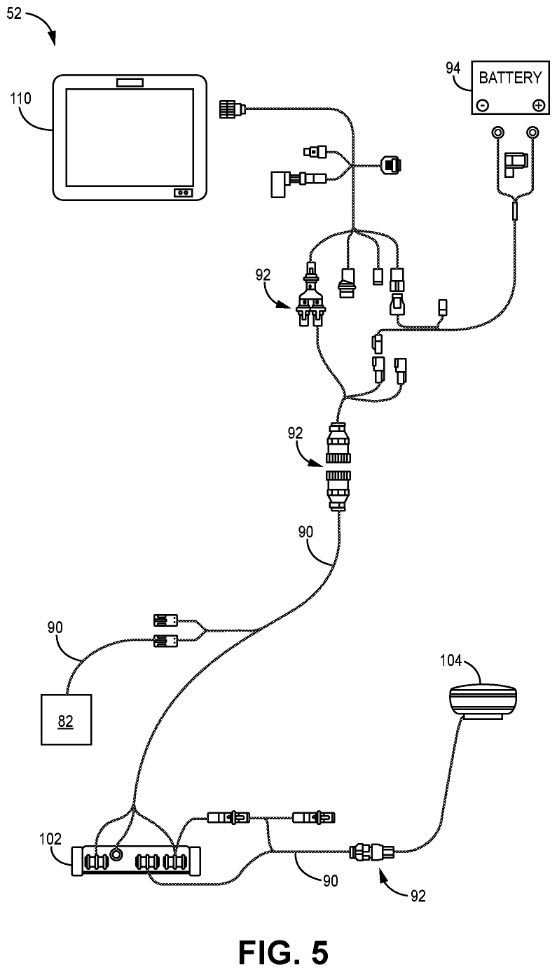

Another embodiment of a sensor system 52 is depicted in FIG. 5, in which the system 52 is depicted separate from a plow. As shown, the system 52 has a GPS receiver/transmitter 104 that can be disposed on a plow. In one implementation, the receiver/transmitter 104 can be disposed on the plow in a fashion similar to the receiver/transmitter 104 discussed above. Alternatively, the receiver/transmitter 104 can be disposed anywhere on the plow as desired. In these and other implementations, the GPS receiver/transmitter 104 is connected to the system module 102 via a cable 90 or other wired or wireless connection component.

The module 102 may be further coupled to a display/interface 110 via another cable 90 or other wireless or wired connector. As shown in this embodiment, various couplers 92 of various known types can be incorporated into the various cables (such as cables 90) at various points to allow for the cables (such as cables 90) or other components of the system 52 to be removed and/or replaced. Alternatively, additional couplers 92 could be incorporated, or fewer or no couplers can be included. In one implementation, the force sensor 82 of this system 52 is coupled to the cable 90 (or any other portion of the system 52) via a separate cable 90 or connection to the cable 90. In certain alternative implementations, the system 52 can have a power source 94 such as, for example, a battery 94 that provides power to the various components of the system 52. It is understood that the various components of the system 52 can be positioned on a plow and/or a prime mover in a fashion similar to the previous embodiments discussed above. Alternatively, the various components can be positioned on any installation device (not shown) and/or prime mover (not shown) as would be appreciated by those of skill in the art.

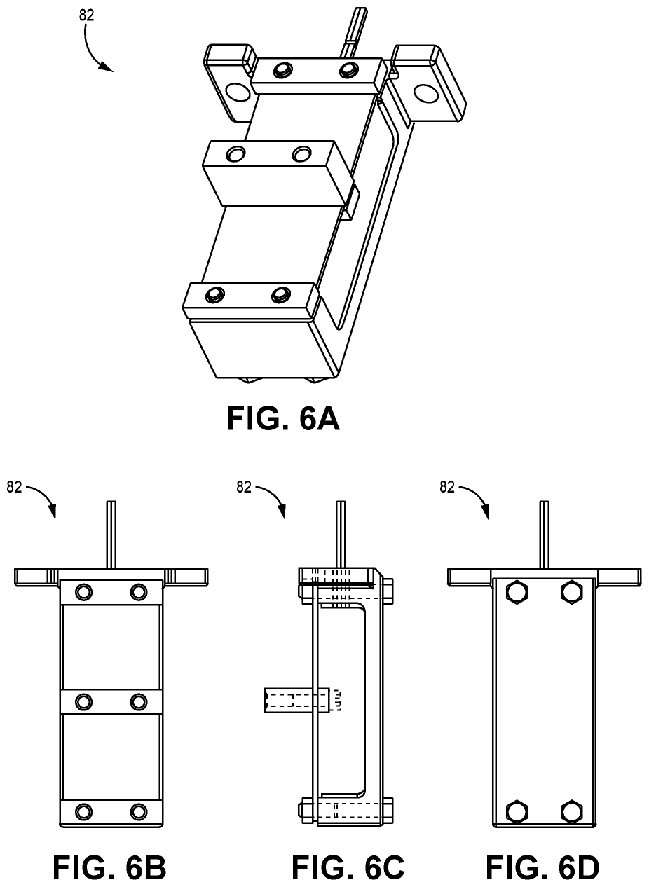

As discussed above, the force sensor 82 in any of the embodiments disclosed or contemplated herein can be any known type of force sensor 82. As also mentioned, the force sensor 82 can be a load cell 82. One embodiment of a load cell 82 is depicted in FIGS. 6A-D. Various load cell 82 configurations are known and appreciated in the art. For example, certain load cells 82 include a piezoelectric transduces to measure force in one direction. That is, in various implementations, the dynamic force on the load cell 82 is the force of the pipe on the contact plate 80. In certain implementations, electricity created by the load cell 82 is monitored by the module 102 (described above). The module 102 may measure the voltage and/or amperage to calculate the amount of tension in the pipe. Various alternative configurations or mechanisms for load cells 82 are contemplated herein and would be appreciated by those of skill in the art, including load cells 82 that would measure force in more than one direction. Alternatively, the load cell 82 incorporated into any system 52 embodiment herein can be any known load cell, such as any commercially-available load cell from Honeywell (Morrisville, N.C.), Kubota (Osaka, Japan), Mettler Toledo (Columbus, Ohio), Interface (Scottsdale, Ariz.), or any other known load cell.

Although the various embodiments have been described with reference to preferred implementations, persons skilled in the art will recognize that changes may be made in form and detail without departing from the spirit and scope thereof.

What is claimed is:

1. A tile plow system, comprising:
(a) a force sensor assembly configured to detect an amount of tension on a conduit being fed through a tile plow;
(b) a system module in communication with the force sensor assembly, the system module comprising:
(i) a processor and
(ii) a memory; and
(c) a display in communication with the system module,
wherein the amount of tension on the conduit is compared to a threshold tension range, and wherein when the amount of tension on the conduit is outside of the threshold tension range a corrective action is taken by the tile plow system.

2. The tile plow system of claim 1, wherein the corrective action includes one or more of change in tractor speed, change in feeder speed, and cessation of tilling.

3. The tile plow system of claim 1, wherein the force sensor assembly comprises a contact plate disposed within a lumen of a shank of the tile plow operatively coupled to a force sensor.

4. The tile plow system of claim 3, wherein force applied to the contact plate is transferred to the force sensor.

5. The tile plow system of claim 3. further comprising a sensor casing configured to be a protective cover over the force sensor assembly.

6. The tile plow system of claim 1, further comprising a GNSS receiver in communication with the system module.

7. The tile plow system of claim 1, wherein the system module emits a warning when the amount of tension on the conduit is within a cautionary range.

8. A tile installation device, comprising:
(a) a sensor assembly, comprising:
(i) a contact plate disposed within a lumen of a shank; and
(ii) a force sensor coupled to the contact plate via a coupling body; and
(b) a processor configured to process force data from the force sensor,
wherein force applied to a flexible pipe exiting the shank is applied to the contact plate and actual force is detected by the force sensor, the actual force is compared to a threshold force range, and when the actual force is outside of the threshold force range the tile installation device applies a corrective action.

9. The tile installation device of claim 8, wherein the force sensor is a load cell.

10. The tile installation device of claim 8, further comprising a sensor casing disposed over the force sensor.

11. The tile installation device of claim 8, wherein the contact plate is disposed within the lumen of the shank proximal to a discharge opening of the shank.

12. The tile installation device of claim 8, wherein the corrective action is one or more of change in tractor speed, change in feeder speed, cessation of tilling, and emitting an alarm.

13. The tile installation device of claim 8, further comprising a display in communication with the processor, the display configured to display one or more of actual force and threshold force range.

14. The tile installation device of claim 13, wherein the display emits a visual or auditory warning when the threshold force range is exceeded.

15. A tile plow, comprising:
(a) a shank pivotally attached to a frame;
(b) a channel defined through the shank;
(c) a force sensor apparatus, comprising:
(i) a contact plate disposed within the channel; and
(ii) a force sensor coupled to the contact plate; and
(d) a processor in communication with the force sensor,
wherein actual force from the force sensor is transmitted to the processor, the actual force is compared to a threshold force range, and when the actual force is outside of the threshold force range the tile plow applies a corrective action.

16. The tile plow of claim 15, wherein the force sensor is a load cell.

17. The tile plow of claim 15, wherein the contact plate is disposed proximal to a discharge opening of the shank, wherein force applied to a pipe exiting the discharge opening is applied to the contact plate.

18. The tile plow of claim 15, wherein the corrective action is one or more of change in tractor speed, change in feeder speed, cessation of tilling, and emitting an alarm.

19. The tile plow of claim 15, wherein the threshold force range comprises three categories an acceptable range, a cautionary range, and a damaging range.

20. The tile plow of claim 15, wherein the corrective action to taken automatically by the tile plow.
